(19) United States
(12) Patent Application Publication
(10) Pub. No.: US 2008/0114610 A1
(43) Pub. Date: May 15, 2008

(54) SYSTEM AND METHOD FOR MARKING MEMORIALS

(76) Inventors: Paul West, Germantown, TN (US); Melissa B. West, Germantown, TN (US)

Correspondence Address: W. EDWARD RAMAGE, COMMERCE CENTER SUITE 1000, 211 COMMERCE ST, NASHVILLE, TN, 37201, US

(21) Appl. No.: 11/862,896

(22) Filed: Sep. 27, 2007

Related U.S. Application Data
(60) Provisional application No. 60/827,142, filed on Sep. 27, 2006.

(51) Int. Cl. G06Q 10/00; G06Q 30/00

(52) U.S. Cl. 705/1

(57) ABSTRACT

A system for offering memorials, markers, monuments, and similar death care items through the Internet or a network in conjunction with a charity or similar donative entity or institution. The marker (or other item) is shown on a web-page accessible through the Internet. Potential customers can view and browse markers or other items available through any standard means of viewing Internet web pages. The customer may determine whether or not to have the name, logo, image, or other indicia of the charity or donative entity (or entities) placed on the marker or other item selected. Upon completing the purchase, a portion of the funds received from the customer is sent to the appropriate charity or donative entity, or a payment recipient for or designated by the charity or donative entity.

This application claims benefit of U.S. Provisional App. No. 60/827,142, filed Sep. 27, 2006, by Paul West, et al., and is entitled to that filing date for priority. The entire disclosure, specification, attachments, and drawings of the above application are incorporated herein by specific reference.

### FIELD OF INVENTION

This invention relates to a system and associated methods for the solicitation and sale of memorial markers in conjunction with a charitable donation system.

### BACKGROUND OF THE INVENTION

The sales of memorials, monuments and similar markers is well-known. However, no system is known for offering such markers and memorials in conjunction with a charity or similar donative entity or institution. It is to this that the present invention is directed.

### SUMMARY OF THE INVENTION

The present invention comprises a system and method for offering memorials, markers, monuments, and similar death care items through the Internet in conjunction with a charity or similar donative entity or institution. In one exemplary embodiment, the marker (or other item) is shown on a web-page accessible through the Internet. Potential customers can view and browse markers or other items available through any standard means of viewing Internet web pages. The customer may determine whether or not to have the name, logo, image, or other indicia of the charity or donative entity (or entities) placed on the marker or other item selected.

Upon completing the purchase, a portion of the funds received from the customer is sent to the appropriate charity or donative entity, or a payment recipient for or designated by the charity or donative entity. The portion of funds can be a set percentage or amount, a variable percentage or amount, a percentage or amount based on the cost or type of the marker or item purchased, or a percentage or amount requested by the customer. In one embodiment, the customer may be asked if they wish to donate any additional amount to the charity or donative entity, with said additional amount be added to the price of the marker or item, and sent to the appropriate charity or donative entity as above. The marker or item then is manufactured, prepared and sent to the customer, or to another recipient as directed by the customer.

### DESCRIPTION OF THE DRAWINGS

FIG. 1 is an diagram of a system in accordance with one embodiment of the present invention.

### DETAILED DESCRIPTION OF EXEMPLARY EMBODIMENTS

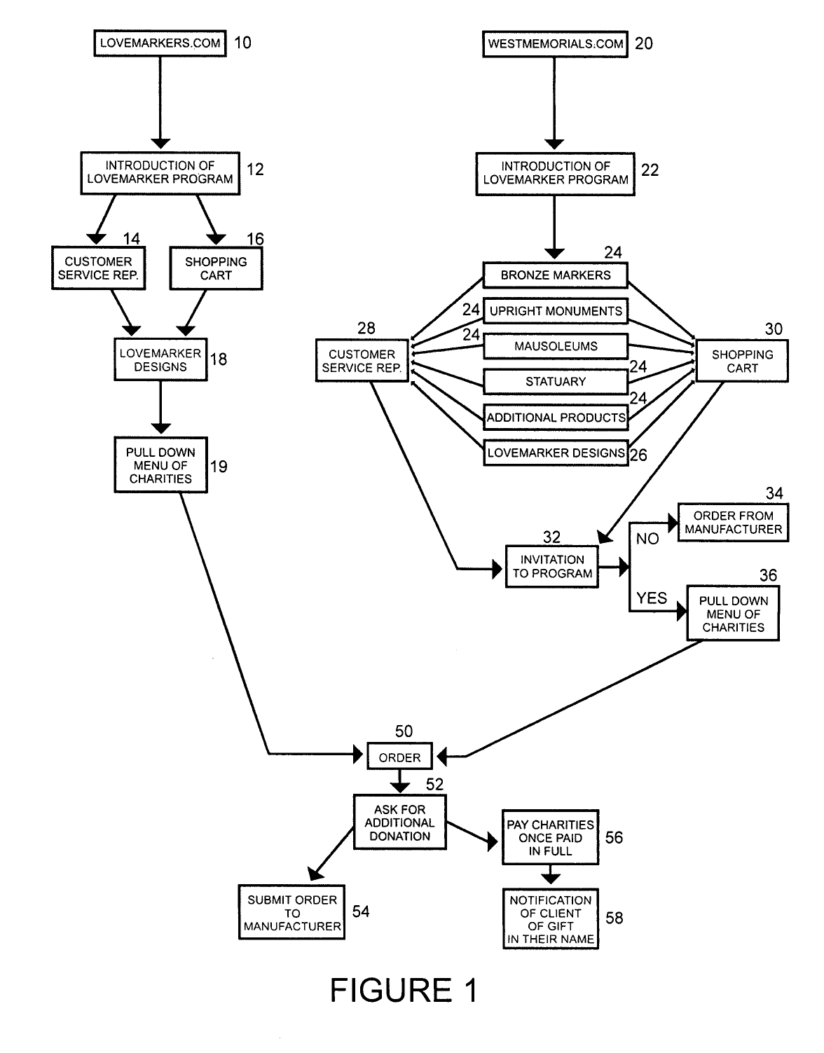

FIG. 1 shows a diagram of an exemplary embodiment of a system for offering memorials, markers, monuments, and similar death care items through the Internet or a network in conjunction with a charity or similar donative entity or institution. The marker (or other item) is shown on a web-page accessible through the Internet. Potential customers can view and browse markers or other items available through any standard means of viewing Internet web pages.

In one exemplary embodiment, access to the system may be gained by one or more web-pages 10, 20 accessible through the Internet. FIG. 1 shows two such web-pages: “lovemarkers.com” 10 and “westmemorials.com” 20. In this configuration, the first web-page 10 takes users directly to the system of the present invention, while the second web-page 20 takes users through a memorial-purchasing web site which incorporates the present invention. Different web-page URLs may be used, and one or three or more web-pages are possible.

In one embodiment, the customer may select to enter the marking program directly 10, and thus marker and items shown would be limited to markers and items available in the program. Upon entering the first website 10, users may be introduced to or told about a program comprising the present invention (referred to as the “Lovemarker” program on FIG. 1) 12. The user then is presented with the option of communicating directly with a customer service representative 14 or making a purchase using the Internet (e.g., through a “shopping cart” or other means of making a purchase on the Internet) 16. Available “Lovemarker” designs for the user to choose from are presented on the web-site, in a brochure, through pictures, or by other similar means 18. Designs may include the name, logo, image, or other indicia of a charity or donative entity (or entities). Possible charities or donative entities may also be provided by means of a list or menu, such as a pull-down menu 19.

Upon entering the second web-site, users also may be introduced to or told about a program comprising the present invention (referred to as the “Lovemarker” program on FIG. 1) 22. Alternatively, this introduction may be done at the same time or after the presentation of memorial and other item options 24. Particular “Lovemarker” designs 26 may be presented at this time as well. As above, the user has the option of communicating directly with a customer service representative 28 or making a purchase using the Internet (e.g., through a “shopping cart” or other means of making a purchase on the Internet) 30. In either case, the user is invited to participate 32 in the “Lovemarker” program. If the user declines, then his or her selected items are ordered from the manufacturer as usual 34. If the user accepts, then possible charities or donative entities may be provided by means of a list or menu, such as a pull-down menu 36.

From either path, after selecting one or more charities or donative entities 19, 36, the user is taken to an site to complete the order 50. As part of order completion, the user may be presented with the option of making an additional, direct donation 52 (i.e., beyond the donation that will be made as part of the purchase of the memorial or other item). If the users declines, the order is sent to the manufacturer 54 and a portion of the proceeds from the sale are sent to the charity or donative entity. If the user accepts, in addition to the order being sent 54 and a portion of the proceeds being sent, an additional amount as designated by the user is sent to the charity 56. Once receipt of the payment by the charity has been confirmed, the user (or other person) may be notified of the gift in their name 58.

In an alternative embodiment, after selecting a marker or item for purchase or potential purchase, the user or customer is prompted by the system to indicate if they would like to participate in the marking program where a portion of their proceeds from their purchase is donated to charity. A brief description of the program may be provided at this stage, and a link to one or more pages with more detailed information may also be provided.

In various alternative embodiments, at a time before, during, or after collecting the basic information regarding the marker (e.g., name, dates, etc.) or other items being purchase, the system prompts the customer to select the charity or other donative entity to be associated with the marker or other item. The selection may be entered or typed in by the customer directly, selected from a list provided on a web page, selected from a pull-down tab or list, or through similar means. One or more charities or donative entities may be selected.

In a variation on the above embodiments, the customer may determine whether or not to have the name, logo, image, or other indicia of the charity or donative entity (or entities) placed on the marker or other item selected. In an alternative embodiment, this option is provided only for those charities or donative entities that have consented to have their name, logo, image, or other indicia used in the manner described. In yet another alternative embodiment, this option may only be provided for charities or donative entities who have agreed to exclusivity with regard to the system. The list of charities or donative entities to which donations may be made can include charities and donative entities for which no name, logo, image, or other indicia may be used in the manner described above.

As described above, upon completing the purchase, a portion of the funds received from the customer is sent to the appropriate charity or donative entity, or a payment recipient for or designated by the charity or donative entity. The portion of funds can be a set percentage or amount, a variable percentage or amount, a percentage or amount based on the cost or type of the marker or item purchased, or a percentage or amount requested by the customer. In one embodiment, the customer may be asked if they wish to donate any additional amount to the charity or donative entity, with said additional amount be added to the price of the marker or item, and sent to the appropriate charity or donative entity as above.

The marker or item then is manufactured, prepared and sent to the customer, or to another recipient as directed by the customer.

The above system can be used with bronze markers, custom monuments, civic memorials, mausoleums, caskets, urns, and other similar death care related items. The above system also can be used with entities, agencies, or organizations other than charities or similar donative entities.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

We claim:

1. A method for offering memorials, markers, monuments, and similar death care items through the Internet, comprising:
presenting a customer with a selection of memorials, markers, monuments and death care items for purchase on an Internet web-site;
providing the customer the option of selecting one or more charities or similar donative entities or institutions to be associated with the selected item or items;
accepting an order and payment from the user for the selected item or items; and
sending a portion of said payment to said charity or similar donative entity or institution associated with the selected item or items.

2. The method of claim 1, wherein the item or items is marked with the name, logo, image, or other indicia of the charity or donative entity or institution.

3. The method of claim 1, wherein the presentation step is performed through a web-site dedicated to the presentation of such items associated with a charity or similar donative entity or institution.

4. The method of claim 1, wherein the presentation step is performed through a web-site for the general presentation and sale of such items, regardless of whether associated with a charity or similar donative entity or institution.

5. The method of claim 1, wherein the portion paid to the charity or similar donative entity or institution is a set percentage or amount, or a variable percentage or amount.

6. The method of claim 5, wherein the percentage or amount is based on the cost or type of the item selected.

7. The method of claim 1, further comprising the steps of:
asking the customer if they wish to donate an additional amount to one or more charities or similar donative entities or institutions;
collecting the additional amount or amounts from the customer; and
sending the additional amount or amounts to the appropriate charity or similar donative entity or institution.

8. A memorial or marker, comprising:
a memorial, marker, or monument marked with a name, logo, image, or other indicia of one or more charities or donative entities or institutions.

9. The memorial or marker of claim 8, wherein a portion of the cost of the memorial, marker, or monument is received by the charity or donative entity or institution.
